(19) United States
(12) Patent Application Publication
(10) Pub. No.: US 2004/0041659 A1
(43) Pub. Date: Mar. 4, 2004

(54) Compact broadband divider/combiner

(75) Inventor: William G. Erlinger, Simi Valley, CA (US)

Correspondence Address: Lowrie, Lando & Anastasi, LLP, One Main Street, Cambridge, MA, 02142, US

(73) Assignee: Forem U.S.A., Amesbury, MA

(21) Appl. No.: 10/460,045

(22) Filed: Jun. 12, 2003

Related U.S. Application Data
(60) Provisional application No. 60/388,092, filed on Jun. 12, 2002.

(51) Int. Cl. H01P 5/12

(52) U.S. Cl. 333/125

(57) ABSTRACT

The invention relates to a compact power combiner/divider. One embodiment comprises:

a circular top housing including a first plurality of radial walls extending downward from a bottom side, a circular bottom housing including a second plurality of radial walls extending upward from a top side, and a plurality of output ports spaced along at least a portion of the top housing and the bottom housing. The circular top housing and circular bottom housing are adapted to fit together to form a substantially closed structure. The first plurality of radial walls and the second plurality of radial walls are substantially concentrically interleaved, thereby creating a plurality of spacings between the walls to form an interdigitated radial chamber.

### CROSS REFERENCE TO RELATED APPLICATIONS

This application claims priority under 35 U.S.C. §119(e) to U.S. Provisional Application No. 60/388,092 entitled “Compact Broadband Divider/Combiner”, filed Jun. 12, 2002, which is herein incorporated by reference in its entirety.

### BACKGROUND

This invention relates to dividing and combining signals. More particularly, this invention relates to an apparatus capable of dividing a signal into numerous signals and to combining numerous signals into a single signal, and which does so without the need for significant tuning and while substantially maintaining amplitude and phase balance.

Generally, there are three types of radio-frequency (RF) or microwave power dividers: lumped element equivalent bandpass dividers, radial waveguide dividers, and corporate dividers. Lumped element equivalent bandpass dividers are usually realized as a cascade of stepped impedance radial transmission lines, and are usually not capable of a large transmission bandwidth in a small diameter structure. Although the thickness of a lumped element bandpass divider design is relatively small, the diameter and the number of sections required can be relatively large.

Radial waveguide dividers have cavities that are large relative to a wavelength of a signal at their operating frequency. While able to provide very high power transmission, cavity type dividers do not usually provide a large bandwidth, being capable of usually only octave bandwidth performance. With radial waveguide cavity type dividers, the divider diameter tends to increase with larger bandwidth, for a given frequency. For example, for a 3 GHz signal, a 50-way divider having an 8″ cavity provides a bandwidth of less than 10% and a voltage standing wave ratio (“VSWR”) of about 1.5:1.

Corporate dividers usually include a cascade of two-way dividers, and are generally lossy and physically large because, to obtain a relatively large bandwidth, corporate dividers require a lot of sections. Corporate dividers employ a cascade of sections to split one signal into an even number of output signals. However, such a cascaded divider is very lossy due to the insertion loss associated with each divider section, and losses associated with junction discontinuities where one section is connected to another. Furthermore, since a corporate divider accommodates only an even number of sections, and the number of divider levels increases as the number of sections increases (at a power of two for each additional section), the corporate divider does not allow an arbitrary or an odd number of levels. For these reasons, corporate dividers are rendered impractical for high-power, signal-amplifier applications.

### SUMMARY OF THE INVENTION

Therefore, a relatively small and simple divider having broad bandwidth capability is needed. In some embodiments, a divider not suffering from the higher order waveguide molding such as that occurring in radial waveguide dividers is needed.

In one embodiment, a radio frequency (“RF”) power divider/combiner includes a circular, symmetric interdigital filter. The power divider/combiner includes a circular top housing having a first center and a first circumference, and a circular bottom housing having a second center and a second circumference, a plurality of ports at circumferential positions, and a longitudinal axis extending from the first center to the second center. The circular top housing includes a first top side and a first bottom side, and a first plurality of finite thickness radial walls extending from the first bottom side. The first plurality of radial walls are concentric about the first center. The circular bottom housing, having a second top side and a second bottom side, includes a second plurality of finite thickness radial walls extending from the second top side, the second plurality of radial walls being concentric about the second center. The circular top housing and the circular bottom housing are joined to form a substantially closed structure, and the first plurality of radial walls and the second plurality of radial walls are substantially and concentrically interleaved forming an interdigitated radial chamber extending from the longitudinal axis to approximately the circular symmetric interdigital filter first and second circumferences.

The circular bottom housing also includes a bottom conductor having a first longitudinal axis which is substantially parallel to the longitudinal axis, extending from the second top side of the circular bottom housing, and being substantially parallel to the longitudinal axis. The bottom conductor is substantially enclosed by a top conductor extending from the first top side of the circular top housing, the top conductor having a second longitudinal axis which is substantially parallel to the longitudinal axis.

The present invention also provides a method of transmitting an input signal. The method includes dividing the input signal into a plurality of in-phase, and substantially equal-amplitude signals, and transmitting the plurality of in-phase, and substantially equal-amplitude signals. The present invention further provides a method of providing the same signals to a phased array antenna. Furthermore, the present invention also provides a method of transmitting a combined signal. The method includes receiving a plurality of in-phase and equal amplitude input signals, combining the plurality of in-phase and equal amplitude input signals, and transmitting the combined signals at a common port.

Other features and advantages of the invention will become apparent by consideration of the detailed description and accompanying drawings.

### BRIEF DESCRIPTION OF THE DRAWINGS

In the drawings:

FIG. 1 is a top view of a compact broadband divider/combiner according to the present invention;

FIG. 2 is an isometric sectional view of a compact broadband divider/combiner taken along line A-A of FIG. 1;

FIG. 3 is a simplified sectional view of a compact broadband divider/combiner taken along line A-A of FIG. 1;

FIG. 4A is a first equivalent circuit of a compact broadband divider/combiner;

FIG. 4B is a second equivalent circuit of a compact broadband divider/combiner including a plurality of series capacitors;

FIG, 4C is a third equivalent circuit of a compact broadband divider/combiner including an input series capacitor;

FIG. 4D is a fourth equivalent circuit of a compact broadband divider/combiner including an output series capacitor;

FIG. 4E is a wedge equivalent circuit of a compact broadband divider/combiner;

FIG. 5 is a first basic sectional view of a compact broadband divider/combiner, showing a first plurality of impedances;

FIG. 6 is a second basic sectional view of a compact broadband divider/combiner, showing a second plurality of impedances; and

FIG. 7 is a plot of a power split of the compact broadband divider/combiner.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

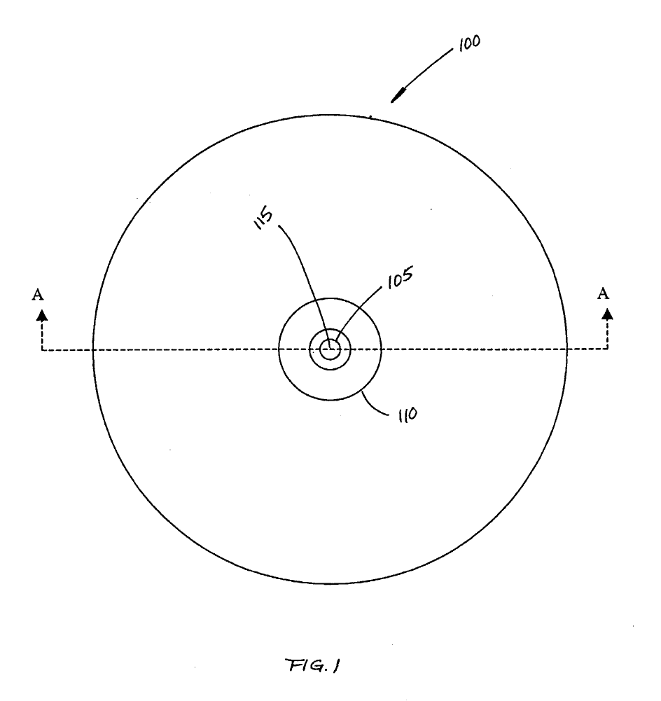

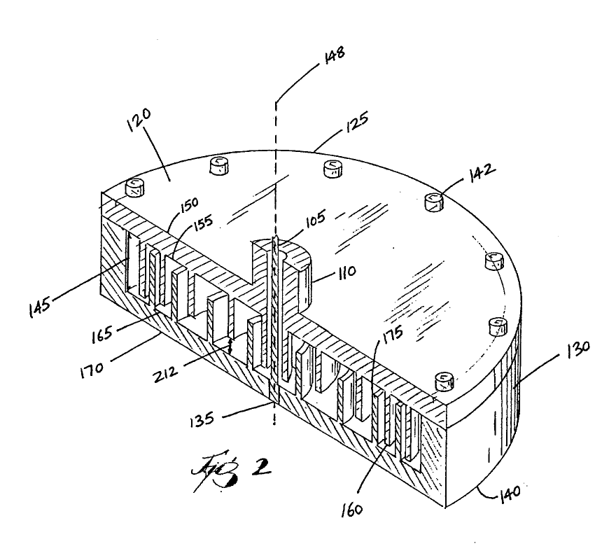

To obtain multi-octave bandwidth performance with a compact structure, a circular symmetric interdigital filter is used because the theoretical performance of the interdigital filter is known a priori. A compact broadband divider/combiner 100 (hereinafter “divider”), according to one embodiment of the present invention is shown in FIG. 1. As would be apparent to those of ordinary skill in the art, the “divider” 100 can operate in two modes: one mode where it divides one input signal into many output signals and another mode where it combines many input signals into one output signal. However, rather than referring to a “divider/combiner,” for simplicity the term “divider” is used throughout this discussion. Of course, it should be understood that the invention may also be used as a divider only, or as a combiner only, if desired. The divider 100 includes a center conductor 105, a top housing extension 110, and a first center 115. The divider 100 also includes an interdigital filter, as shown in FIG. 2.

Referring to FIG. 2, the divider 100 may include a circular top housing 120 having a first circumference 125, and a circular bottom housing 130 having a second center 135 and a second circumference 140. The circular top housing 120 is mounted to the circular bottom housing 130 with a plurality of fasteners 142, thereby creating an overall inside height 145. The fasteners 142 may be, for example, screws, bolts, or the like, or adhesives or tapes or combinations thereof. A longitudinal axis 148 extends from the first center 115 to the second center 135. The circular top housing 120, having a first top side 150 and a first bottom side 155, may include a first plurality of finite thickness radial walls 160 extending from the first bottom side 155, the first radial walls 160 being concentric about the first center 115. The circular bottom housing 130, having a second top side 165 and a second bottom side 170, may include a second plurality of finite thickness radial walls 175 extending from the second top side 165, the second radial walls 175 being concentric about the second center 135, thereby creating a plurality of spacings 180 between the radial walls 160 and 175. The circular top housing 120 and the circular bottom housing 130 fit together and provide a substantially closed structure. The radial walls 160 and the radial walls 175 are substantially and concentrically interleaved, thereby forming an interdigitated chamber radially extending from the longitudinal axis 148 to approximately the circular symmetric interdigital filter first and second circumferences 125 and 140.

The circular bottom housing 130 also includes a center conductor 105 having a first longitudinal axis, extending from the second top side 165 of the circular bottom housing 130, and being substantially parallel to the longitudinal axis 148. The center conductor 105 is substantially enclosed by an outer conductor or a top housing extension 110 extending from the first top side 150 of the circular top housing 120, and the top housing extension 110 has a second longitudinal axis which is substantially parallel to the longitudinal axis 148.

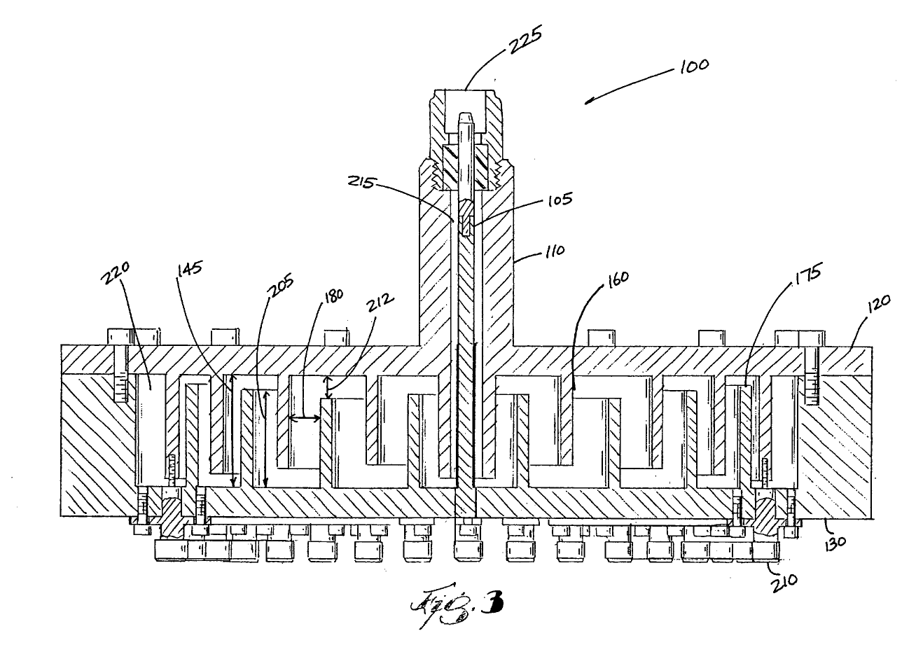

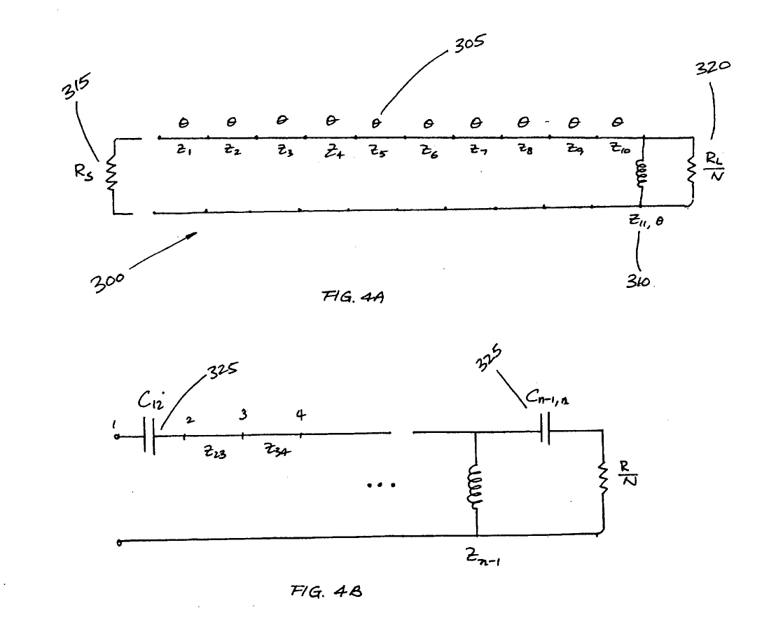

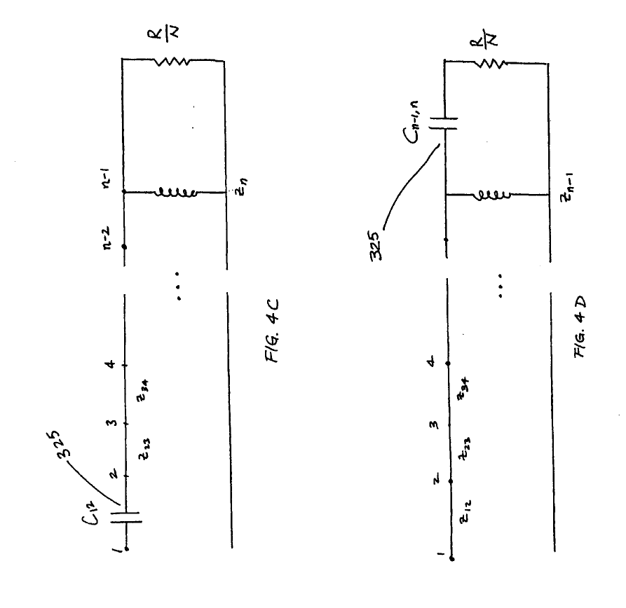

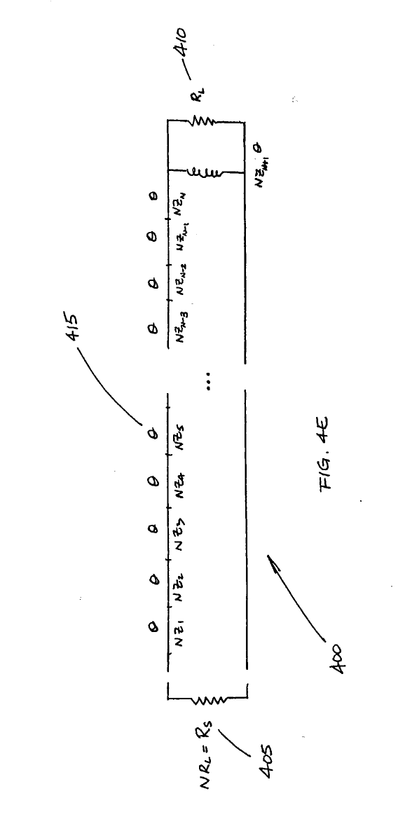

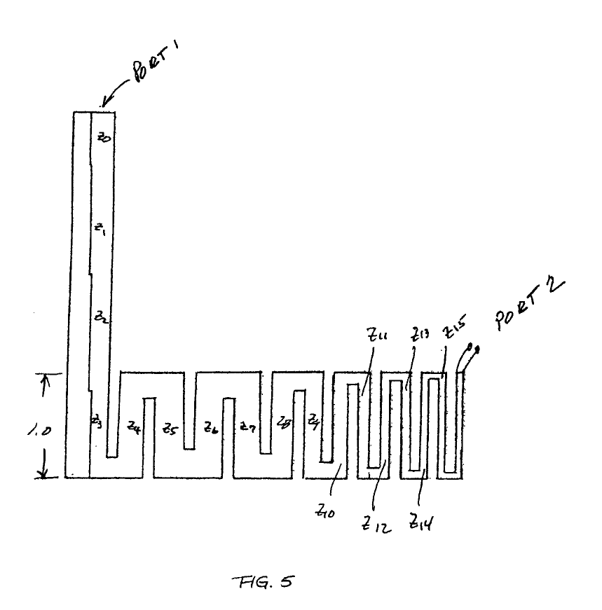

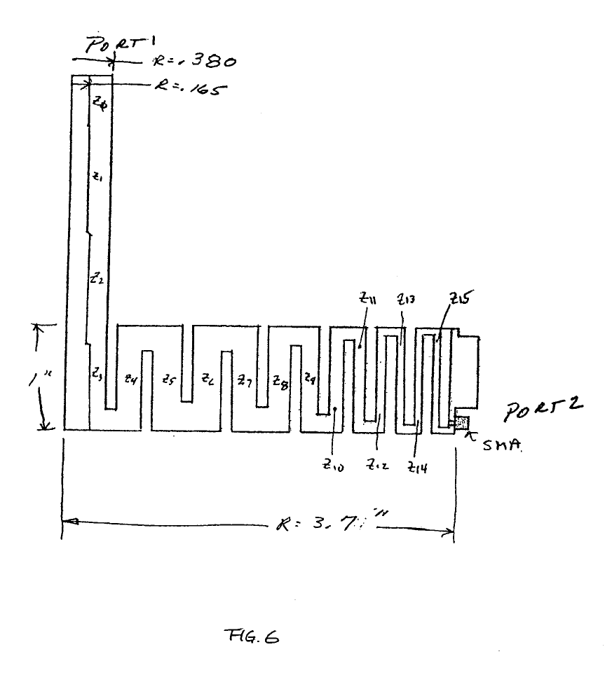

Referring to FIG. 3, each of the radial walls 160 and 175 has a height 205. A plurality of output ports 210 are spaced along the radial walls 160 and 175. The spacing 180 between the walls determines the unit element (“LJE”) impedance of an equivalent circuit (shown in FIG. 4A). Specifically, the height 205 essentially determines an electrical length of a transmission line whose impedance is determined by a spacing 180 between the first wall 160 and the second wall 175. In one example, the overall inside height 145 is essentially a quarter wavelength at the center of the divider operating frequency range. According to one embodiment, the divider 100 may be based on an N =11 chebychev stub/UE filter having a bandwidth of 6.6:1, with a voltage standing-wave ratio (“VSWR”) level of 1.05:1, and the number of output ports 210 set at 36. The first two UEs of the equivalent circuit, illustrated in FIG. 4A, may be realized in a two-section feed line 215, having two diameters between the inside diameter of the top housing extension 110 and the diameter of the center conductor 105. In addition, each gap 212 between the walls corresponds to a UE in the equivalent circuit in FIG. 4A. The last spacing 180 realizes a shunt inductor 220 in the equivalent circuit in FIG. 4A. The plurality of output ports may attach directly to the last wall at 10° intervals around the outer periphery of the divider for 36 outputs. The center conductor 105 may also have a different number of sections and thus different diameters to represent a different number of UEs, as shown in FIGS. 5 and 6, if desired.

FIG. 4A shows one example of an equivalent circuit 300 of the entire divider 100. The equivalent circuit 300 includes a cascade of UEs 305 with a shunt inductor 310 at an output port 210 (FIG. 3), a source impedance 315, and a load impedance 320. A source resistance (labeled Rₛ) may be preferably about 50Ω, and a load resistance (labeled R_{L}) is, therefore 50Ω/N where N is the number of output ports 210. The impedance of each UE 305 decreases as the UEs get closer to the shunt inductor 310. For example, with Rₛ set at 50Ω and N set at 36 (which results in R_{L}/N being 50/NΩ and the phase angle φ being 90° at the center frequency), the impedance (expressed as zₙ) for each UE shown is as follows: zᵢ is 46.8Ω, z₂ is 41.4Ω, z₃ is 33.9Ω, z₄ is 25.4Ω, z₅ is 17.6Ω, z₆ is 11.5Ω, z₇ is 7.2Ω, z₈ is 4.4Ω, z₉ is 2.7Ω, z₁₀ is 1.7Ω, and z₁₁ is 5.5Ω. Additional examples of equivalent circuits illustrating the entire divider circuit are shown in FIGS. 4B, 4C and 4D. These circuits include a plurality of series capacitors 325. Each capacitor 325 is distributed and is a quarter wavelength at the design center frequency, where n is the number of sections. FIG. 4E shows a wedge equivalent circuit 400 where a 360°/N wedge of a divider is taken. The wedge equivalent circuit 400 includes a source impedance 405 (Rₛ), a load impedance 410 (R_{L}), and a plurality of UE impedances 415. The source impedance 405 is normally 50NΩ, the load impedance R_{L}=Rₛ/N and is, therefore, 50Ω, and the plurality of UE impedances 415 are N*zᵢΩ, where i ranges from 1 to N+1.

Referring to FIG. 3, the divider 100 receives a signal at the input port, which is at the center 115 of the divider 100. The signal energy travels in and meanders through the concentric rings. The gap 212 between the wall 160 and the second top side 165 acts as a transmission line. The signal energy goes in and travels through the gap 212, making a right angle bend and travels into the next gap or transmission line. The diameter of the cascade of transmission lines get larger as the signal energy moves through the chamber to the outer diameter of the concentric circle, while the impedance level drops with the lowest impedance being at the load 320.

When the device is operating as a divider, each of the N output ports may be preferably terminated with an impedance of 50Ω. Since the output ports are in parallel, the equivalent circuit in FIG. 4A has a load of 50Ω/N where N is the number of output ports. A signal at an input port 225 travels through the feed line 215 in a transverse electromagnetic (“TEM”) mode and meanders radially outward through the radial chamber towards the plurality of output ports 210. Because of circular symmetry, all output signals have equal phase and amplitude characteristics. The output port 210 (in the last concentric ring at 10° intervals) is filled with a pressed-in spring finger which accepts a center pin of an output connector. According to one embodiment, the connectors may be subminiature RF connectors or SMA connectors that meet predefined interface mating dimensions. Preferably, the dimensions meet the requirements of the MIL-C-39012 specification. In one example, a Type N connector pin is soldered to the center conductor 105 at the top housing extension 110, and the center conductor 105 is press fit into the circular bottom housing 130. The plurality of gaps 212 from an open end of the concentric rings are adjusted to compensate for the 180° bend between adjacent UEs. As would be apparent to one of ordinary skill in the art, almost any arbitrary number of output ports can be used. The output port intervals can be adjusted to the number of ports chosen. For example, if 24 output ports are desired, the interval will be 360°/24=15°. Furthermore, adjusting the thickness of the radial walls 160 and 175 affects the response of the divider 100. For example, the radial wall 175 thickness affects the spacing 180 and the overall diameter of the divider 100. Increasing the radial wall thickness requires an increase of spacing 180 and, therefore, an increase in the diameter of the divider 100.

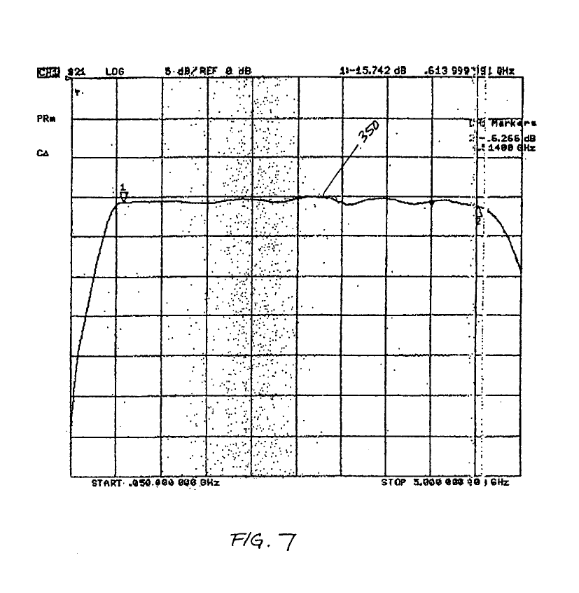

In the combiner mode, N in-phase and equal amplitude signals are fed into the N ports, the signals are then combined in-phase at the common port with no loss of power except for reflection and dissipation losses. Reflection losses are the same as those at the common port when used as a divider. Additional combining losses are related to errors in amplitude and phase of the N signals. FIG. 7 shows a power split response plot using the embodiment described above. The measured result illustrates the broadband capability of the invention with a return loss that is approximately less than 15 dB over a 6.5:1 band.

Embodiments of the invention are capable of multi-octave bandwidth performance in a compact structure. In the embodiment shown, the physical structure is simple and requires at most one solder joint, requires little or no tuning, and the number of ports ranges from 2 to more than 100. Furthermore, because of the circular symmetry design, both the amplitude and the phase balance are theoretically perfect.

Due to the circular symmetry design of the invention, phase and amplitude balance is not affected by the discontinuities in the structure. However, discontinuities can affect the VSWR of the system, and the amplitude and the phase are, in most instances, affected by any eccentricity between the circular top housing 120 and the circular bottom housing 130. For example, the response plot shown in FIG. 7 shows, instead of a flat response from an ideal divider/combiner, a series of ripples 350. Eccentricity may also cause some output ports 210 to receive more power at a particular frequency than the other output ports 210. However, amplitude and phase imbalance may be minimized by monitoring the output power balance and adjusting the relative position of the circular top housing 120 relative to the circular bottom housing 130.

As can be seen from the above, embodiments of the invention provide a divider/combiner with broad bandwidth capability. The invention may be used to divide a signal into plurality of output signals and to combine a plurality of input signals to a single output signal. The combiner can be used in many applications, such as telecommunications applications, and with phased array antennas.

1. A power combiner/divider comprising:
a circular top housing having a first center and a first circumference and including a bottom side and a first plurality of radial walls extending downward from the bottom side, the first plurality of radial walls being concentric about the first center;
a circular bottom housing having a second center and a second circumference and including a top side and a second plurality of radial walls extending upward from the top side, the second plurality of radial walls being concentric about the second center; and
a plurality of output ports spaced along at least a portion of the first circumference and the second circumference;
wherein the circular top housing and circular bottom housing are adapted to fit together to form a substantially closed structure; and
wherein the first plurality of radial walls and the second plurality of radial walls are substantially concentrically interleaved, thereby creating a plurality of spacings between the walls to form an interdigitated radial chamber.

2. The power combiner/divider as claimed in claim 1, wherein the plurality of output ports are evenly spaced.

3. The power combiner/divider as claimed in claim 1, wherein the first circumference is defined by an outer one of the first plurality of radial walls and wherein the second circumference is defined by an outer one of the second plurality of radial walls.

4. The power combiner/divider as claimed in claim 1, wherein the circular bottom housing includes a bottom conductor extending upward from the top side, at least a portion of the bottom conductor being substantially enclosed by a housing extension extending from a second bottom side of the circular top housing.

5. The power combiner/divider as claimed in claim 4, wherein the housing extension is a top conductor.

6. The power combiner/divider as claimed in claim 4, wherein the bottom conductor includes a first section having a first diameter and a second section having a second diameter different from the first diameter.

7. The power combiner/divider as claimed in claim 1, wherein a height of each of the first plurality of radial walls and the second plurality of radial walls is approximately a quarter wavelength at substantially a center of an operating frequency range of the power combiner/divider.

8. A power combiner/divider comprising:
a top housing having a first center and a first periphery and including a bottom side and a first plurality of walls extending downward from the bottom side;
a bottom housing having a second center and a second periphery and including a top side and a second plurality of walls extending upward from the top side;
a plurality of output ports spaced along at least a portion of the first periphery and the second periphery;
wherein the top housing and bottom housing are adapted to fit together to form a substantially closed structure; and
wherein the first plurality of walls and the second plurality of walls are substantially interleaved, thereby creating a plurality of spacings between the walls to form an interdigitated chamber.

9. The power combiner/divider as claimed in claim 8, wherein the plurality of output ports are evenly spaced.

10. The power combiner/divider as claimed in claim 8, wherein the first periphery is defined by an outer one of the first plurality of walls and wherein the second periphery is defined by an outer one of the second plurality of walls.

11. The power combiner/divider as claimed in claim 8, wherein the bottom housing includes a bottom conductor extending upward from the top side, at least a portion of the bottom conductor being substantially enclosed by a housing extension extending from a second bottom side of the top housing.

12. The power combiner/divider as claimed in claim 11, wherein the housing extension is a top conductor.

13. The power combiner/divider as claimed in claim 11, wherein the bottom conductor includes a first section having a first diameter and a second section having a second diameter different from the first diameter.

14. The power combiner/divider as claimed in claim 8, wherein a height of each of the first plurality of walls and the second plurality of walls is approximately a quarter wavelength at substantially a center of an operating frequency range of the power combiner/divider.
